(19) United States
(12) Patent Application Publication
(10) Pub. No.: US 2026/0010237 A1
(43) Pub. Date: Jan. 8, 2026

(54) GESTURE ENTRY ON A DEVICE

(71) Applicant: GOOGLE LLC, Mountain View, CA (US)

(72) Inventor: Ishan Chatterjee, Seattle, WA (US)

(21) Appl. No.: 19/261,557

(22) Filed: Jul. 7, 2025

Related U.S. Application Data
(60) Provisional application No. 63/668,599, filed on Jul. 8, 2024.

(51) Int. Cl. G06F 3/01; G06F 3/04886

(52) U.S. Cl. CPC G06F 3/017; G06F 3/013; G06F 3/04886

(57) ABSTRACT

According to at least one implementation, a method includes identifying a first state for a gesture from a user of a device and determining a first location associated with the gesture. The method further includes determining a second location on an interface displayed by the device based on the first location and causing display of an identifier in the second location on the interface.

### CROSS-REFERENCE TO RELATED APPLICATION

This application claims priority to U.S. Provisional Application No. 63/668,599, filed on Jul. 8, 2024, the disclosure of which is incorporated by reference herein in its entirety.

### BACKGROUND

A head-worn device is a wearable technology designed to be worn on or around the head, including smart glasses, augmented reality (AR) and virtual reality (VR) headsets, extended reality (XR) devices, and head-mounted displays. These devices typically feature advanced sensors, displays, and communication interfaces to support immersive and interactive experiences. Users can provide input through multiple methods, including physical buttons, touch-sensitive surfaces, voice commands, gesture recognition, eye detection, and external controllers.

### SUMMARY

This disclosure relates to systems and methods for gesture entry for a virtual keyboard on a wearable device. The wearable device can include an extended reality (XR) device, smart glasses, or other wearable devices. In at least one example, a method includes identifying a first state or starting state for a gesture of a user of the device and determining a first location associated with the gesture in response to identifying the first state. In some implementations, the gesture can include a pinching, tapping, or other type of gesture that the device can identify. The method further comprises determining a second location on an interface, such as a keyboard, displayed by the device based on the first location and displaying an identifier in the second location on the interface.

In some examples, the method can further include determining when the gesture is in a second state or a completed state, and identifying an input based on the current location of the identifier in response to the gesture being in the second state.

In some aspects, the techniques described herein relate to a method including: identifying a first state for a gesture from a user of a device; determining a first location associated with the gesture; determining a second location on an interface displayed by the device based on the first location; and causing display of an identifier in the second location on the interface.

In some aspects, the techniques described herein relate to a system including: at least one processor; a computer-readable storage medium operatively coupled to the at least one processor; and program instructions stored on the computer-readable storage medium that, when executed by the at least one processor, direct the system to perform a method, the method including: identifying a first state for a gesture from a user of a device; determining a first location associated with the gesture; determining a second location on an interface displayed by the device based on the first location; and causing display of an identifier in the second location on the interface.

In some aspects, the techniques described herein relate to a computer-readable storage medium having program instructions stored thereon that, when executed by at least one processor, direct the at least one processor to perform a method, the method including: identifying a first state for a gesture from a user of a device; determining a first location associated with the gesture; determining a second location on an interface displayed by the device based on the first location; and causing display of an identifier in the second location on the interface.

The accompanying drawings and the description below outline the details of one or more implementations. Other features will be apparent from the description, drawings, and claims.

### BRIEF DESCRIPTION OF THE DRAWINGS

FIG. 1 illustrates a system for providing user input to a virtual keyboard on a device according to an implementation.

FIG. 2 illustrates a system for providing user input to a virtual keyboard on a device according to an implementation.

FIG. 3A illustrates a method of operating a device to provide gesture entry for a virtual keyboard according to an implementation.

FIG. 3B illustrates a method of operating a device to provide gesture entry for a virtual keyboard according to an implementation.

FIG. 4 illustrates an operational scenario of receiving gesture input to a virtual keyboard according to an implementation.

FIG. 5 illustrates an operational scenario of receiving gesture input to a virtual keyboard according to an implementation.

FIG. 6A illustrates an operational scenario of updating a display based on gesture input to a virtual keyboard according to an implementation.

FIG. 6B illustrates an operational scenario 650 of receiving gesture input to an interface displayed by a wearable device according to an implementation.

FIG. 7 illustrates a computing system for providing user input to a virtual keyboard on a device according to an implementation.

### DETAILED DESCRIPTION

Examples herein support gesture entry for a virtual keyboard on a wearable device. In some examples, a wearable device, such as an Extended Reality (XR) headset or smart glasses, encompasses a range of technologies that blend the physical and virtual worlds, creating immersive experiences. These devices can include Virtual Reality (VR) devices, which fully immerse users in a computer-generated environment, Augmented Reality (AR) devices, which overlay digital information onto the real world, and Mixed Reality (MR) devices, which merge real and virtual elements interactively. Wearable devices can be used in various gaming, education, training, and remote collaboration applications. The devices enhance how users perceive and interact with their surroundings by integrating digital content seamlessly with the physical world.

Input on a wearable device can be received through a combination of sensors, controllers, and tracking systems. Users can interact with the virtual environment using handheld controllers, motion sensors, eye-tracking, voice commands, or other input mechanisms. Cameras and sensors on the device can track the user's head movements and position, and further detect hand movements and gestures. In some examples, wearable devices may use body tracking to capture the movement of the entire body or specific parts, like hands, for more precise interaction. However, at least one technical problem with wearable devices is the inability of users to provide text input without using voice, a physical keyboard, or another secondary input device.

As at least one technical solution, a device can be configured to provide a virtual keyboard that permits the user to provide input using pinching gestures. In at least one implementation, a keyboard is displayed on the device. The display can comprise a screen or set of screens that present virtual or augmented content to the user, typically through head-mounted displays (HMDs) or smart glasses. These displays can provide an immersive visual experience by covering a wide field of view. The displays can incorporate stereoscopic three-dimensional (3D) visuals, allowing users to perceive depth and interact with the digital elements as if they were part of the physical world. In some implementations, the keyboard can be overlaid over content or the physical world within the field of view of the end user.

To provide input to the keyboard, the device can be configured to identify pinching gestures from the user and determine the location of the gestures (gestures made without touching an input device) relative to the keyboard displayed by the device. In some implementations, a pinch gesture is identified using a combination of hand-monitoring cameras, sensors, and models (such as machine learning models). The device's cameras and sensors capture the position and movement of the user's hands and fingers in real time. Models can then analyze these movements to detect specific gestures like pinching. Once a pinch gesture is recognized, the system translates it into a corresponding action within the virtual or augmented environment associated with the device. In some examples, the device can be configured to determine a meeting location associated with a pinch gesture, wherein the meeting location corresponds to the estimated location in space for the meeting of the fingers associated with the gesture (i.e., completion location). The meeting location can be determined using a combination of hardware and software that identifies the location of the hand or fingers related to the gesture. The location of the gesture in space (e.g., in three-dimensional space) is then mapped to a location on the keyboard (e.g., in the display space).

In at least one technical solution, the location on the keyboard is determined based on a vector between the user's gaze and the gesture location. The location relative to the keyboard is where the vector intersects the keyboard on the display (e.g., the lens of an XR device). Thus, when the vector intersects a character on the keyboard, the character is identified in association with the gesture. For example, the user can view a keyboard and raise their hand to provide input to the keyboard via a pinching gesture. The wearable device can display the keyboard for the user either as a 2D or 3D overlay anchored in space. For example, the keyboard can appear to be floating in front of the user in some examples. The device can be configured to identify the location of the gesture by capturing hand and/or body movements using onboard cameras and depth sensors. The device can then process the visual and spatial data through computer vision algorithms to estimate the position of the gesture relative to a coordinate system associated with the device (e.g., the position of the pinch). The device can then determine the user's gaze and determine a vector from the user's gaze to the gesture. The intersection of the vector through the keyboard can correspond to the location on the keyboard.

In other technical solutions, the device can map a gesture space (e.g., a two-dimensional space or a physical space for gesture motion) outside the user's field of view to the keyboard space. For example, the device can use at least one sensor or camera to capture the user's gesture, wherein the user may provide the gesture in an ergonomic position (e.g., resting on a table). The location of the gesture in space can then be mapped to a space associated with the keyboard. Thus, the device can be configured to identify a first location associated with a pinching gesture and map the first location to a second location on the keyboard. The first location can correspond to a physical space (e.g., the three-dimensional physical environment for the user), and the second location can correspond to a display space, including the display of the keyboard for the user.

For example, the user can rest their hands on a desk and start a pinching gesture. The device can be configured to identify the position of the pinching gesture in 3D space by capturing image and depth data using integrated cameras and sensors. The device processes this data through computer vision algorithms to estimate the three-dimensional coordinates of the gesture relative to a defined spatial reference frame. The coordinates of the gesture can then be transformed or translated to display coordinates for the display of the keyboard. The location on the keyboard can then be displayed using a cursor or indicator (i.e., identifier), permitting the user to identify the location for the completed gesture. Thus, the user can initiate the gesture in a first position in space (i.e., first state or start state), and the device can translate the position to a display position over the letter “R” on the keyboard. The device can display an indicator associated with the letter “R” (e.g., highlight the key on the keyboard, provide a cursor over the letter, etc.), permitting the user to identify the potential input. When the user finishes the gesture (i.e., touches the finger to the thumb), the device can register the input associated with the letter “R.” The completion of the gesture can be referred to as a second state or a completed state.

In at least one implementation, the device can be configured to display a cursor (or indicator) on the keyboard corresponding to the determined gesture location relative to the keyboard. A cursor is a movable indicator on a computer screen or display that shows a user's position or point of interaction, allowing them to select a particular character from the keyboard. For example, a cursor can be displayed for gestures associated with each hand. As at least one technical effect, when the user raises their hands in a pinching gesture, the device can be configured to identify the meeting locations for the gestures and display them on the display. As an example, when a gesture is in a location associated with the letter “R” on a keyboard, a cursor is displayed over the letter “R.” When the user completes the gesture, the device can be configured to provide input associated with the letter “R” to an application. In some implementations, the device can be configured to display any indicator (including a cursor) in the identified second location for the keyboard. The indicator can include a cursor, a lighted key on the keyboard (e.g., the letter “A”), a highlighted portion of the keyboard, or some other identifier corresponding to the second location. In some implementations, the indicator's display can change based on the state associated with the gesture. For example, when the user is providing a pinching gesture, a first representation of an indicator can be positioned on the keyboard associated with the potential input location. When the user completes the gesture, the device can be configured to display a second representation of the indicator. For example, the user can start a pinching gesture (i.e., without touching the pointer finger and thumb), and a first indicator representation can be positioned over the letter “R.” When the user completes the pinching gesture (i.e., the pointer finger and thumb are touching), a second indicator representation can be displayed over the letter “R.” The different representations can include various colors, opacity, shapes, or any other variation of indicators.

In at least one technical solution, the device can be configured with a model that determines the likely positions of the gesture relative to the keyboard. The device can be configured to predict or adjust the location of the gesture using advanced language models, such as neural networks, that analyze the context of the current text and the user's typing habits. These systems rely on comprehensive dictionaries, statistical analysis, and machine learning techniques to generate and rank potential following words or letters based on their probability. Additionally, the device can be configured to personalize predictions by learning from the user's writing style and frequently used phrases, enabling accurate and contextually relevant suggestions that improve over time. For example, while the sensors on the device can indicate that the user gesture is identified in association with the letter “R,” the model can be used to display a cursor over the letter “E” if it is determined that the letter is more likely in association with the user's input. Thus, the device can be configured to adjust the displayed cursor based on predictive modeling. The models can also be adjusted based on user movement habits and corrections, wherein limited mobility or range of motion can place the cursor in different locations on the keyboard based on feedback or monitoring by the device.

Although demonstrated in the previous examples using a pinching gesture, other types of gestures can be reflected and displayed on the keyboard. These other gestures can include clapping gestures (or otherwise putting two extremities together, such as pointer fingers), tapping gestures (e.g., tapping on a surface using fingers or some other object), or gestures. In at least one example, the device can be configured to identify a gesture from a user of the device and identify a location associated with the gesture, wherein the location corresponds to the completion of the gesture. In some examples, the completion location corresponds to the predicted location in physical space for the completion of the gesture, such as touching fingers for a pinching gesture. In some examples, the location corresponds to a coordinate in three-dimensional space determined by one or more sensors. The system can further be configured to identify a mapping of the location to a second location on a keyboard displayed by the device, and display a cursor in the second location on the keyboard.

Although demonstrated in the previous examples as using a keyboard, similar operations can be performed with other input devices like a keyboard. These devices can include keypads, keyboards, Musical Instrument Digital Interface (MIDI) controllers, audio controllers, button panels, sliders, etc. The device can be configured to display an interface (i.e., virtual interface) and identify input using the gesture identification operations described herein. For example, the wearable device can display a MIDI controller for a musical artist. The artist can use gestures to provide input to the MIDI controller and select one or more buttons or other interfaces using the operations described herein. For example, the user can initiate a pinching gesture (start state associated with a finger and thumb at a first distance) that is identified by the device. The device can determine the location of the pinching gesture and determine a second location on the display of the MIDI controller based on the location. The wearable device can display an identifier in the second location, permitting the artist to identify the location of a potential input. When the user completes the gesture (e.g., an end state based on the finger and thumb at a second distance or touching), the input on the MIDI controller can be identified from the current location of the gesture, and the corresponding action can be taken. As a technical effect, the artist can identify where a gesture will be input before completing the gesture.

As an illustrative example of the methods and systems described herein, a wearable device can include a web browser application that provides search functionality to the device. A web browser is a software application used to access and view websites on the internet. It retrieves content from web servers and displays it to the user, allowing interaction with text, images, videos, and other web-based resource. To provide the search, the user can initiate a pinching gesture using one or more of their hands. In response to detecting the gesture, the wearable device can determine the location of the gesture and determine a second location for an identifier on a keyboard displayed by the device. For example, the user can raise their right-hand into a pinching gesture position that is captured using cameras and/or sensors on the device. The wearable device can identify a pinching gesture using cameras or sensors that track the position of the user's fingers and detect when the thumb and index finger come close together. The location of the pinching gesture is determined by calculating the midpoint between the tracked fingertip positions in 3D space, relative to the environment or coordinate system. In some examples, the location can also be a location relative to the user's gaze, permitting the keyboard intersection of a vector between the gesture and user's gaze to be used as the second location. In some examples, the 3D location (e.g., 3D coordinates) can be mapped or translated to a second location on the keyboard. The wearable device can then display an identifier on the keyboard, indicating a potential input position. Once the user completes the gesture, the character corresponding to the input location can be provided to an application or service. As a result, the user can provide multiple gesture inputs to support the web search (e.g., a search for “space shuttle”). Once the user completes the desired input, the identifiers can be removed from the display based on the user's hands no longer being in the position associated with gesture input.

In another illustrative example of the systems and methods described herein, the user can place their hands in an ergonomic position associated with tapping their fingers onto a surface, such as a tabletop. The device can detect the position of the hands for the gesture using one or more sensors or cameras that capture the position, orientation, and the like associated with the user's hands. In response to detecting the placement of the hands in a tapping position (i.e., keyboard input position with fingers lifted off the table), the wearable device can determine input locations for the tapping gestures on a keyboard displayed by the device. In some implementations, the device can translate or map the 3D position of the user's hands in space to a location on the keyboard. As a technical effect, the user can view potential input positions before completing a gesture (e.g., tapping their finger on the table), then complete the gesture with the desired characters. In some examples, the location of the gesture is determined based on the estimated meeting point of the user's finger to the table. The location can then be mapped to a location on the displayed keyboard for the user. This permits the user to identify character input locations without a physical keyboard.

When the user completes the gesture (i.e., a tap on the table), the system can determine a current character associated with the physical location and provide the character to an application or service. In some implementations, the device can further demonstrate the input character by displaying feedback. The feedback can include text indicating the pressed character, a change in the identifier from a first to a second version, or some other indicator. For example, the user can use their hands to provide tapping gestures to generate an email. The device can monitor the tapping gestures and display indicators or identifiers on the display of a virtual keyboard, permitting the user to identify the location of potential inputs. In some examples, the identifier can include a virtual representation of the user's hand, indicating where inputs will be received on the virtual keyboard.

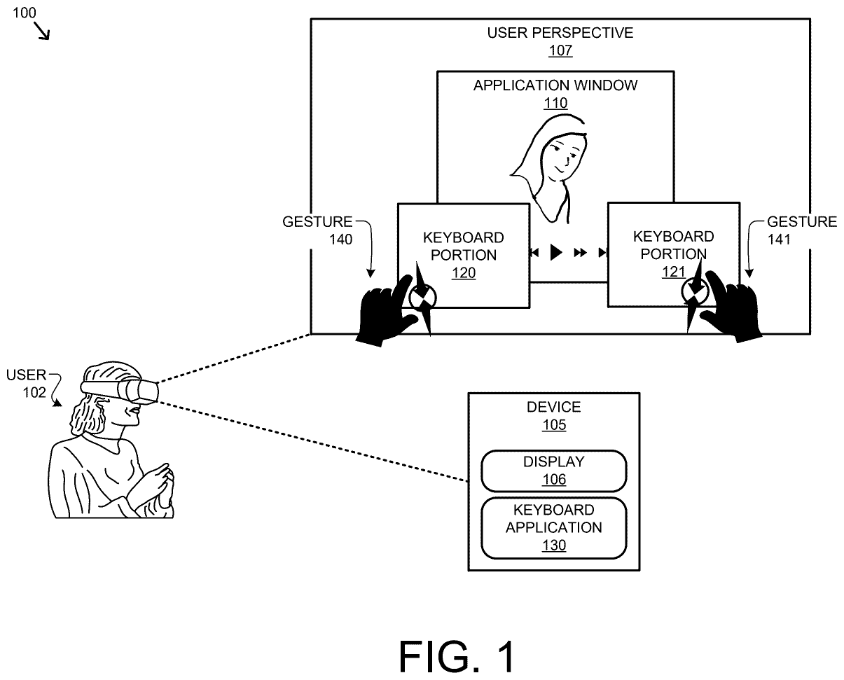

FIG. 1 illustrates a system 100 for providing user input to a virtual keyboard on a device according to an implementation. System 100 includes user 102, device 105, and user perspective 107. Device 105 includes display 106 and provides keyboard application 130 to provide keyboard input for the device using a virtual keyboard. User perspective 107 includes application window 110, keyboard portion 120, keyboard portion 121, gesture 140, and gesture 141. Although demonstrated with two keyboard portions (e.g., for a right and left hand), the keyboard can be a single portion or divided into any number of portions.

In computing system 100, keyboard application 130 displays keyboard portions 120 and 121 for input by user 102. The user provides gestures 140 and 141, such as pinching, tapping, or other gestures, whose locations are mapped to positions associated with keyboard portions 120 and 121. In some examples, indicators (or cursors) can be displayed at the positions associated with keyboard portions 120 and 121.

Device 105 can include a high-resolution display 106 (or displays), integrated motion sensors, outward-facing cameras, depth sensors, and at least one processor to handle graphics and data processing. Additionally, device 105 can feature audio systems, haptic feedback mechanisms, wired or wireless connectivity options, battery packs for portability, and ergonomic designs for extended user comfort. In some implementations, device 105 can include at least one camera or sensor that tracks gestures provided by the user of device 105. In some examples, a sensor or camera can track user gestures by capturing real-time data on movements and positions, which is then processed by algorithms on device 105 to interpret specific gestures. In some implementations, the integrated motion sensors detect changes in orientation and acceleration, while the cameras and depth sensors create a detailed 3D map of the environment, allowing the system to recognize and respond to hand and body gestures accurately.

In at least one technical solution, device 105 is configured with keyboard application 130, which displays a keyboard on the device's display. A keyboard is displayed on device 105 as a virtual interface, overlaid onto the user's field of view through display 106 (or projected onto a physical surface using augmented reality). In some implementations, the keyboard includes keyboard portion 120, which is representative of the left portion of the keyboard, and keyboard portion 121, which is representative of the right portion of the keyboard. The user of device 105 provides gestures 140-141. Device 105 is configured to use at least one sensor or camera to identify gestures 140-141 and determine the location of the gesture relative to the keyboard (keyboard portions 120-121).

In the example of system 100, device 105 can track the gaze vector to the gesture location and determine the intersection with the keyboard portions on the display included in user perspective 107. For example, the user's right hand can make a pinching gesture, which involves bringing the thumb and another finger, typically the index finger, together to simulate pinching. When the user raises their right hand (for the gesture), a sensor or camera on the device can identify a location associated with potentially completing the gesture. Device 105 can be configured to determine a vector between the user's gaze and the gesture and determine the vector's intersection with the keyboard on the device's display. Thus, when the vector intersects the letter “L” with the user's right hand, a cursor can be displayed over the letter “L” on the display. When the user completes the gesture, device 105 can be configured to identify the completion and determine a keyboard character associated with the location of the gesture at the time of completion. Device 105 can then supply the keyboard character to the service or application associated with text input. For example, if the user completes a pinching gesture in a location associated with the letter “L” while in a web browsing application, then device 105 and keyboard application 130 can identify the completion of the gesture and provide the character to the web browsing application (e.g., the application associated with a text input cursor).

In some examples, device 105 can display an indicator corresponding to the user's potential input. For example, when user 102 provides gesture 140, the device can determine a location associated with the completion of the gesture. The location corresponds to an estimated completion location (e.g., the forefinger and thumb touching in space). A vector is then generated from the gaze of the user (e.g., from the user's eye) to the estimated completion location. Where the vector intersects the display of keyboard portion 120 on display 106, an indicator can be displayed for user 102. When user 102 completes the gesture (i.e., completes the pinching action), the indicator can be updated from a first to a second representation, indicating that the input was registered and can further indicate the character selected using the gesture.

In some implementations, device 105 can be configured to use a predictive model or language model to identify potential inputs for the user. In some examples, a character prediction model can determine or predict a next character based on a sequence of previously entered characters. The model receives a series of input characters and analyzes their contextual relationships using a language model, such as a transformer, recurrent neural network (RNN), an n-gram model, or another language model. Device 105 can determine a probability distribution over possible following characters and select the character with the highest probability. The prediction may be refined using user-specific history or context associated with the user input in some examples.

In addition to a keyboard, similar operations can be performed with other input devices. Such devices can include keypads, Musical Instrument Digital Interface (MIDI) controllers, or audio controllers. The device can be configured to display a virtual representation of such a device and identify input using the gesture identification operations described herein. For example, a wearable device can display a MIDI controller for a musical artist. The artist can use gestures to provide input to the MIDI controller and select one or more buttons or other interfaces using the operations described herein. For example, a user can initiate a pinching gesture (a start state) that a device identifies. The device can determine the pinching gesture's location and a second location on a display of the MIDI controller based on the location. The wearable device can display an identifier in the second location, permitting the artist to identify a location of a potential input. When the user completes the gesture (e.g., an end state), the input on the MIDI controller can be identified from the current location of the gesture, and a corresponding action can be taken. As a technical effect, the artist can determine where a gesture will be input before completing the gesture.

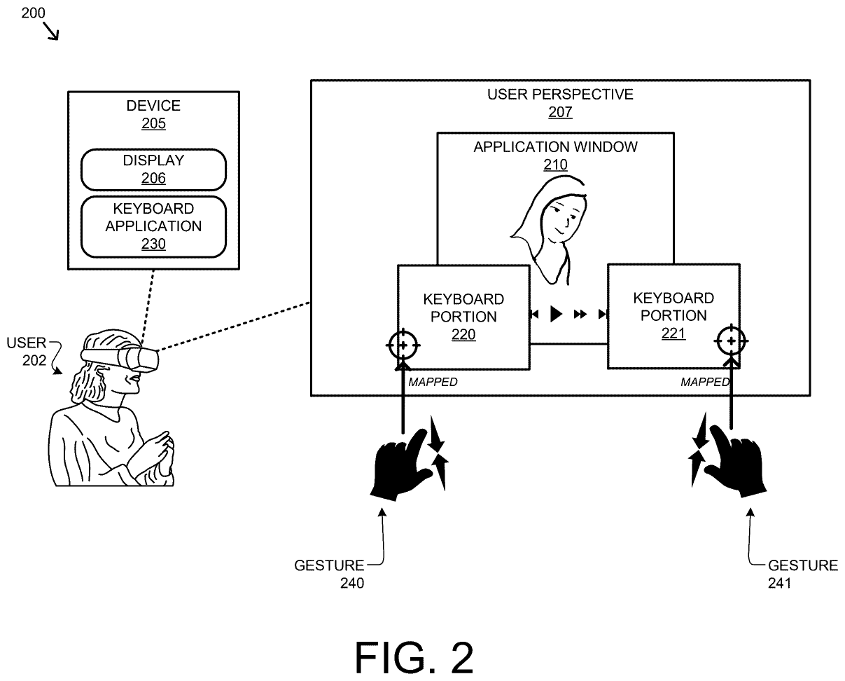

FIG. 2 illustrates a system 200 for providing input for a virtual keyboard on a device according to an implementation. System 200 includes user 202, device 205, and user perspective 207. Device 205 includes display 206 and keyboard application 230, which provides keyboard input for device 205 using a virtual keyboard. User perspective 207 includes application window 210, keyboard portion 220, keyboard portion 221, gesture 240, and gesture 241. Although demonstrated with two keyboard portions (e.g., for a right and left hand), the keyboard can be a single portion or divided into any number of portions.

In system 200, keyboard application 230 and device 205 use one or more sensors and/or cameras to identify gestures 240 and 241. Device 205 can identify a gesture by using sensors, such as cameras or depth sensors, to track the position and movement of user 202 (e.g., the hands of user 202). Device 205 can apply computer vision and machine learning models to classify the motion pattern as a specific gesture (e.g., pinch). The location of the gesture is determined by mapping the tracked body portion (e.g., hand) into the 3D coordinate space relative to the device or environment. Based on the identified location, the system can determine a second location associated with the keyboard presented by device 205. For example, when the user provides gesture 240, the location of gesture 240 is determined as a first location and mapped or translated to a second location on keyboard portion 220. In some examples, device 205 can display an indicator for user perspective 207 that indicates the mapped location on the keyboard portion. For example, while the hands of user 202 may be out of view of the user's perspective, but captured using cameras or sensors associated with device 205. The location in coordinates space can be mapped into a 2D space associated with display 206 and the corresponding keyboard. The mapped location can then be displayed to user 202, permitting user 202 to identify potential input locations associated with the keyboard.

Device 205 can include a high-resolution display or displays, integrated motion sensors, outward-facing cameras, depth sensors, and at least one processor to handle complex graphics and data processing. Additionally, device 205 can feature spatial audio systems, haptic feedback mechanisms, wired or wireless connectivity options, battery packs for portability, and ergonomic designs for extended user comfort. In some implementations, device 205 can include at least one camera or sensor that tracks gestures provided by the user of device 205. In some examples, a sensor or camera can track user gestures by capturing real-time data on movements and positions, which is then processed by algorithms on device 205 to interpret specific gestures. In some implementations, the integrated motion sensors detect changes in orientation and acceleration, while the cameras and depth sensors create a detailed 3D map of the environment, allowing the system to recognize and respond to hand and body gestures accurately. Although not depicted in either FIG. 1 or FIG. 2, a system can include a companion device (e.g., a smartphone, tablet, etc.) that can at least partially keyboard operations described herein.

In at least one technical solution, device 205 is configured with keyboard application 230, which displays a keyboard on the device's display. A keyboard is displayed on device 205 as a virtual interface, overlaid onto the user's field of view through the display, or projected onto a physical surface using augmented reality. Here, the keyboard includes keyboard portion 220, which is representative of the left portion of the keyboard, and keyboard portion 221, which is representative of the right portion of the keyboard. The user of device 205 provides gestures 240 and 241. Device 205 is configured to use at least one sensor or camera to identify gestures 240 and 241 and determine the location of the gesture relative to the keyboard (keyboard portions 220 and 221).

In at least one technical solution depicted in system 200, device 205 is configured to monitor the location of the gesture relative to device 205. For example, motion sensors or cameras can be used to monitor the location of gestures 240-241 while the gestures are not in user perspective 207. Device 205 can then be configured to map the location of the gesture to a location in association with the keyboard represented by keyboard portions 220-221. In at least one example, the device can identify the location of the device in a two-dimensional space (such as a two-dimensional space on the desk). The location is then mapped to a location on the keyboard. When the location on the keyboard is determined, a cursor is displayed to indicate the potential input location. As a technical effect, before completing the pinching gesture, the user can view the potential input location in either keyboard portion 220 or keyboard portion 221.

For example, gesture 241 represents the gesture provided by a user's right hand. Device 205 can identify the location of the gesture using one or more sensors or cameras and map the location to an area (or second location) in keyboard portion 221. Device 205 can be configured to display a cursor (or other indicator) indicating the potential input for gesture 241 on keyboard portion 221. The cursor will be shown over the region (or second location) on keyboard portion 221. Thus, if the region corresponds to the letter “R,” then a cursor will be displayed over the letter “R.”

Once the gesture is completed (e.g., the pinch operation is completed), device 205 can be configured to determine a keyboard character associated with the cursor at the time of gesture completion. The keyboard character can then be provided to an application or service associated with the text input from the keyboard. For example, suppose the keyboard is associated with a web browser's search bar. In that case, the device can identify the keyboard character for a completed user gesture and provide the character to the application. In at least one implementation, a first application (e.g., keyboard application 230) can be used to monitor the gaze and gesture of the user to determine keyboard input, then provide selected keyboard characters from the user to the second application (e.g., a web browser). The technical effect limits the monitoring of user gestures to the first application or operating system and provides only character inputs to the device.

In some implementations, device 205 and keyboard application 230 can be configured to use a predictive model or language model to identify potential inputs for the user. In some examples, a character prediction model can determine or predict a next character based on a sequence of previously entered characters. The model receives a series of input characters and analyzes their contextual relationships using a language model, such as a transformer, recurrent neural network (RNN), an n-gram model, or another language model. Device 205 can determine a probability distribution over possible following characters and select the character with the highest probability. The prediction may be refined using user-specific history or context associated with the user input in some examples.

In some implementations, the user can provide gestures via a tapping operation on a table or other surface. For example, the user can rest their hands on their desk out of view of the user's perspective. Instead, a keyboard can be displayed for the user, permitting the tapping inputs to be registered with the keyboard. When the user lifts a finger (e.g., as initiating an input or a first state), the sensors and or cameras on device 205 can identify the potential input and a location associated with the input in space (e.g., the location on the table associated with the completed tap (i.e., completed or second state)). The location on the table, or the first location, can be mapped to a second location associated with the keyboard on the display. For example, a potential tapping point on the table can be mapped to the location of the letter “R” on the keyboard. Display 206 can display an indicator (e.g., circle, representation of a finger, and the like) over the letter “R” to indicate the input that would occur when the user completes their gesture. When the user completes the gesture, device 205 and keyboard application 230 can provide the input to an application. For example, keyboard application 230 can provide a character to a web browsing application based on the user completing a gesture. In some implementations, keyboard application 230 can provide a visual indication that the gesture was completed, including a change to the indicator, a character identified from the gesture, or some other indicator associated with completing the gesture.

In addition to a keyboard, similar operations can be performed with other input devices. Such devices can include keypads, Musical Instrument Digital Interface (MIDI) controllers, or audio controllers. The device can be configured to display a virtual representation of such a device and identify input using the gesture identification operations described herein. For example, a wearable device can display a MIDI controller for a musical artist. The artist can use gestures to provide input to the MIDI controller and select one or more buttons or other interfaces using the operations described herein. For example, a user can initiate a pinching gesture (a start state) that a device identifies. The device can determine the pinching gesture's location and a second location on a display of the MIDI controller based on the location. The wearable device can display an identifier in the second location, permitting the artist to identify a location of a potential input. When the user completes the gesture (e.g., an end state), the input on the MIDI controller can be identified from the current location of the gesture, and a corresponding action can be taken. As a technical effect, the artist can determine where a gesture will be input before completing the gesture.

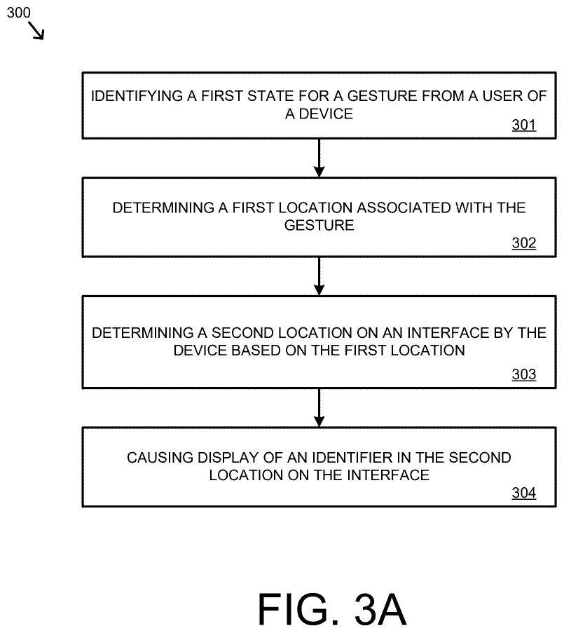

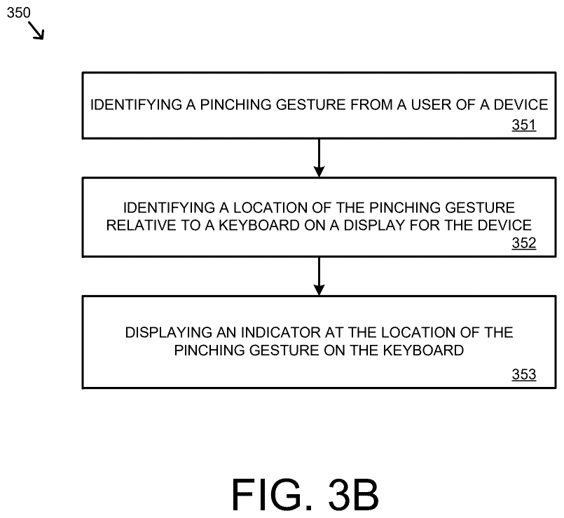

FIG. 3A illustrates method 300 of operating a device to provide gesture entry for a virtual keyboard according to an implementation. Method 300 can be performed by a wearable device, such as an XR device or smart glasses, in some examples. Method 350 can be performed by device 105 of FIG. 1 or device 205 of FIG. 2 in some examples.

Method 300 includes identifying a first state for a gesture from a user of a device at step 301. In some implementations, the first state includes the user starting a gesture. For example, a wearable device can identify the start of a gesture, such as a pinch, using cameras and depth sensors to determine the position and movement of the user's hands. The device can detect portions of the user's hands, such as fingertips and joints, using computer vision and/or machine learning. The device can identify the distance and movement between the thumb and another finger on the user's hand for a pinch. The gesture can be recognized as starting (or in a first state) when the fingers move toward each other or are placed at a threshold distance, indicating an intent to pinch. The device can confirm the start of the gesture by checking the change in distance between the finger and the thumb, marking the start. Similar operations can also be performed to determine when the user is starting a tapping or preparing a tapping gesture on a table. The distance and movement of a finger can be determined relative to the surface.

Method 300 further includes determining a first location associated with the gesture at step 302. In some examples, the first location is determined in response to identifying the gesture in the first state. In some implementations, the location of the gesture corresponds to an anticipated or determined meeting location for the gesture (e.g., between the fingers as part of a pinching gesture, or a location on a table or other surface as part of a tapping gesture). For example, the device can calculate the anticipated meeting location of a pinching gesture by determining the 3D positions of the user's thumb and finger using hand-monitoring sensors and/or cameras. The device can determine the trajectories or predicted motion associated with the body portions and calculate the likely intersection point in space where the pinch will occur. Similar operations can also be performed for a tapping gesture applied to a table. In some examples, the first location corresponds to a position in 3D space associated with completing the gesture (e.g., completing the pinching or tapping gesture).

Method 300 further includes determining a second location on an interface displayed by the device (e.g., keyboard, button panel, etc.) based on the first location at step 303 and causing display of an identifier in the second location on the interface at step 304. In some implementations, the system can be configured to convert or translate the first location to a second location in the display space associated with the device. For example, the device can be configured to determine the location of the gesture (3D coordinate) and map the position to a location on a keyboard displayed by the device.

In some implementations, the displayed interface includes a keyboard. In some examples, the location on the keyboard is determined based on a vector between the user's gaze and the gesture location. The location relative to the keyboard is where the vector intersects the keyboard on the display (e.g., the lens of an XR device). Thus, when the vector intersects a character on the keyboard, the character is identified in association with the gesture. For example, the user can view a keyboard and raise their hand to provide input to the keyboard via a pinching gesture. The wearable device can display the keyboard for the user either as a 2D or 3D overlay anchored in space. In some examples, the keyboard can appear floating in front of the user. The device can be configured to identify the location of the gesture by capturing hand and/or body movements using onboard cameras and depth sensors. The device can then process the visual and spatial data through computer vision algorithms to estimate the position of the gesture relative to a coordinate system associated with the device (e.g., the position of the pinch). The device can then determine the user's gaze and define a vector from the user's gaze to the gesture. The intersection of the vector through the keyboard can correspond to the location on the keyboard. Thus, based on the vector between the user's gaze and the gesture, the device can determine an intersection with the keyboard (e.g., the letter “A”).

In other technical solutions, the device can map a gesture space (e.g., a two-dimensional space or a physical space for gesture motion) outside the user's field of view to the keyboard space. For example, the device can use at least one sensor or camera to capture the user's gesture, wherein the user may provide the gesture in an ergonomic position (e.g., resting on a table). The location of the gesture in space can then be mapped to a space associated with the keyboard. Thus, the device can be configured to identify a first location associated with a pinching gesture and map the first location to a second location on the keyboard. The first location can correspond to a physical space (e.g., the three-dimensional physical environment for the user), and the second location can correspond to a display space, including the display of the keyboard for the user.

For example, a user can rest their hands on a desk and start a pinching gesture. The device can be configured to identify the position of the pinching gesture in 3D space by capturing image and depth data using integrated cameras and sensors. The device processes this data through computer vision algorithms to estimate the three-dimensional coordinates of the gesture relative to a defined spatial reference frame. The gesture coordinates can then be transformed or translated to display coordinates for the keyboard.

In some implementations, the device can be configured to display an indicator or an identifier in the second location. For example, when the user initiates a pinching gesture, the device can identify the location on the keyboard based on the location of the gesture, and generate a display of an identifier. The identifier can include a circle, a pointer, a highlighting of a particular character on the keyboard, or some other identifier or indicator, indicating the potential input location associated with the gesture. Thus, if the user's gesture location is associated with the letter “R,” an identifier can be displayed in association with the letter “R.” The display of the identifier can provide an indication to the user of the resulting character from completing the gesture. In some examples, the identifier can transition from a first representation to a second representation when the user completes the gesture, indicating that the character has been selected. The selection can then be provided to an application or other service executing on the device (e.g., provide the application with the letter “R”).

In some implementations, in addition to considering the user's gesture, the device can further determine likely inputs associated with the keyboard based on predictive language for the user's input. The device can be configured to predict or adjust the location of the gesture using advanced language models, such as neural networks, that analyze the context of the current text and the user's typing habits. These systems rely on comprehensive dictionaries, statistical analysis, and machine learning techniques to generate and rank potential following words or letters based on their probability. Additionally, the device can be configured to personalize predictions by learning from the user's writing style and frequently used phrases, enabling accurate and contextually relevant suggestions that improve over time. For example, while the sensors on the device can indicate that the user gesture is identified in association with the letter “R,” the model can be used to display a cursor over the “F” if it is determined that the letter is more likely in association with the user's input. Thus, the device can be configured to adjust the displayed cursor based on predictive modeling. The models can also be adjusted based on user movement habits and corrections, wherein limited mobility or range of motion can place the cursor in different locations on the keyboard based on feedback or monitoring by the device. As at least one technical effect, the cursor is displayed both during the analysis of the user's gesture and in predictive modeling associated with previous inputs from the user. In at least one example, the predictive modeling can be extended to inputs associated with other interfaces, such as button panels, sliders, and the like. The system can determine frequent sequences of input and adjust the display of the identifier based on the predictive model.

In an illustrative example method 300, users can position their hands in an ergonomic arrangement, such as with fingers poised for tapping on a surface like a tabletop. The device can detect the position of the hands for the gesture using one or more sensors or cameras, which capture the position, orientation, and related characteristics of the user's hands. In response to detecting the placement of the hands in a tapping position, for instance, a posture suitable for keyboard input, the wearable device can determine potential input locations for the tapping gestures on a keyboard presented by the device. In some implementations, the device can translate or map a three-dimensional position of the user's hands in space to a location on the keyboard. As a technical effect, the user can view potential input positions before completing a gesture, such as tapping a finger on a table, and then complete the gesture to select a desired character. In some examples, the location of a gesture is determined based on an estimated meeting point of a user's finger with a table. The location can then be mapped to a location on the presented keyboard for the user. This lets the user identify character input locations without requiring a physical keyboard.

FIG. 3B illustrates a method 350 of operating a device to provide input from a virtual keyboard according to an implementation. Method 350 can be performed by an XR device or some other wearable device in some examples. Method 350 can be performed by device 105 of FIG. 1 or device 205 of FIG. 2 in some examples.

Method 350 includes identifying a pinching gesture from a user of a device 351. The device can be configured to identify the pinching gesture using cameras, motion sensors, or some other hardware element. It can process the movements identified for the user to determine when the movements correspond to a pinching gesture from the user. Method 350 further includes identifying a location of the pinching gesture relative to a keyboard on a screen for the device at step 352. In some implementations, the location of the pinching gesture directly corresponds to the keyboard. For example, the user can raise their hands so that their gaze (i.e., gaze vector) intersects a portion of the keyboard when viewing the gesture (or the expected location for the touch point in the pinching gesture). The area on the keyboard between the gaze and the gesture is identified for step 352. In some implementations, the device can be configured to identify a location of the gesture (e.g., a three-dimensional coordinate associated with the gesture) and identify a vector between the location and the user's gaze. The device can then be configured to map the location of the gesture to a second location on the keyboard based on the intersection of the vector with the displayed keyboard.

In at least one implementation, the gesture can be mapped to the keyboard to let the user rest their hands more ergonomically. For example, the user can rest their hands on a desk or table, and the device can be configured to identify the location of a pinching gesture from the user using cameras and/or sensors. The device is then configured to map the location of the gesture to the keyboard. For example, the device can be configured to identify a two-dimensional space for the movement of the hands for the gesture (e.g., the top of the table). A location in the two-dimensional space is then mapped to a location on the keyboard. For example, a hand in a location on a desk forming a pinching gesture is mapped to a character on the keyboard.

Once the location of the pinching gesture relative to the keyboard is identified, method 350 further includes displaying a cursor in the identified location on the keyboard at step 353. In at least one implementation, the device can be configured to provide cursors for both hands of the user. Thus, a first cursor corresponds to the location of a firsthand, and a second cursor corresponds to the location of a second hand. The different cursors can assist the user in identifying input locations for both hands. In some implementations, the device can be configured to display any identifier (including a cursor) in the identified second location for the keyboard. The identifier can include a cursor, a lighted key on the keyboard (e.g., the letter “A”), a highlighted portion of the keyboard, or some other identifier corresponding to the second location. The identifier can be any visual element that indicates the second location or region on the display.

In some implementations, a device can be configured to identify a gesture from a user of the device and identify a first location associated with the gesture. The first location can be in the physical space (e.g., three-dimensional physical space), and the second location can be in the screen space (e.g., two-dimensional display space). The device can further be configured to identify a second location on a keyboard displayed by the device based on the first location and display an identifier in the second location on the keyboard.

In some implementations, a device can be configured to identify a gesture from a user of the device and identify a first location associated with the gesture. The device can further be configured to map the first location to a second location on a keyboard displayed by the device. In some examples, the mapping includes identifying the first location in a three-dimensional or physical space for the gesture and mapping the first location to the second location in a second space (e.g., the available display space). Once mapped, the device can be configured to display an identifier in the second location on the keyboard (e.g., a cursor, a highlight, or some other identifier).

Although demonstrated in the example of method 350 using a pinching gesture, other types of gestures can be reflected and displayed on the keyboard. These other gestures can include clapping gestures (or otherwise putting two extremities together, such as pointer fingers), tapping gestures (e.g., tapping on a surface using fingers or some other object), or other gestures. In at least one example, the device can be configured to identify a gesture from a user of the device and identify a location associated with the gesture, wherein the location corresponds to the completion of the gesture. In some examples, the completion location corresponds to the predicted location in physical space for the completion of the gesture, such as touching fingers for a pinching gesture. In some examples, the location corresponds to a coordinate in three-dimensional space determined by one or more sensors. The system can further be configured to identify a mapping of the location to a second location on a keyboard displayed by the device, and display a cursor in the second location on the keyboard.

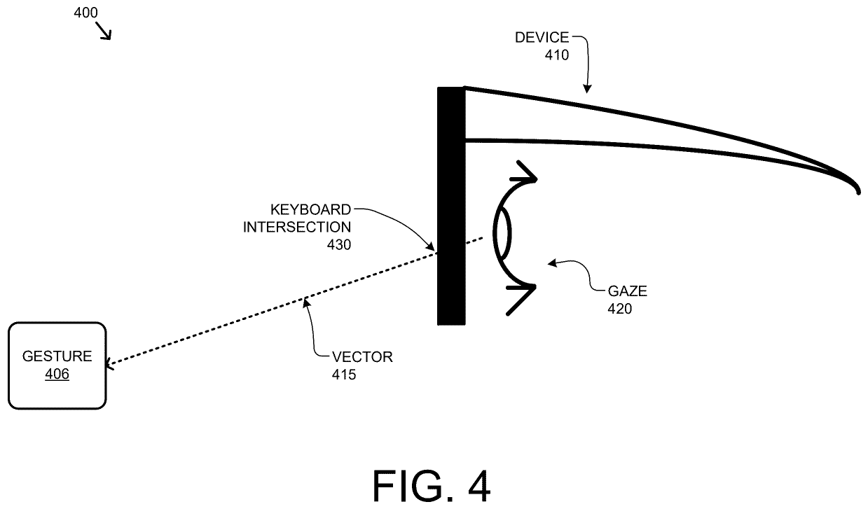

FIG. 4 illustrates an operational scenario 400 of receiving gesture input to a virtual keyboard according to an implementation. Operational scenario 400 includes gesture 406, device 410, vector 415, gaze 420, and keyboard intersection 430.

In operational scenario 400, device 410 can identify the location associated with gesture 406. In some implementations, the location can be determined using one or more cameras and/or sensors that can identify the location of gesture 406 in space. In some examples, device 410 can determine when the user begins a gesture, such as a pinching or tapping gesture. The gesture can be determined based on the location and movement of the user portion (e.g., the fingers and thumb of the user). Once the gesture is identified, device 410 can determine the location of gesture 406 in space (e.g., relative to device 410 or the user environment). In some implementations, device 410 can use sensors and/or cameras to capture the location of the gesture in space. The location can correspond to the potential completion point (e.g., touch point of a pinching gesture).

Once the gesture is identified in space, vector 415 is determined between gaze 420 and gesture 406. In some implementations, gaze 420 can be determined using cameras or infrared sensors integrated into device 410. These sensors can identify the movement and position of the user's eyes. In some examples, device 410 can determine gaze 420 using accelerometers, gyroscopes, and head position sensors, which track head orientation. The location of gesture 406 can then be determined relative to gaze 420 using the determined vector 415. For example, a vector 415 between the user's gaze 420 and gesture 406 is determined to extend from device 410 in the direction of gesture 406. The intersection of vector 415 with a keyboard displayed by the device 410 can then determine an intersection point associated with gesture 406 (e.g., keyboard intersection 430). Keyboard intersection 430 can correspond to a second location on the keyboard where the user initiated gesture 406. For example, keyboard intersection 430 can correspond with character “R” on the keyboard displayed by device 410. Device 410 can then display an identifier at the display location for keyboard intersection 430.

When the user completes gesture 406, device 410 can identify the corresponding character and register the input in the corresponding application. Returning to the previous example, device 410 can identify the character corresponding to the intersection of vector 415 and provide the character to an application or service executing on the device when gesture 406 is completed.

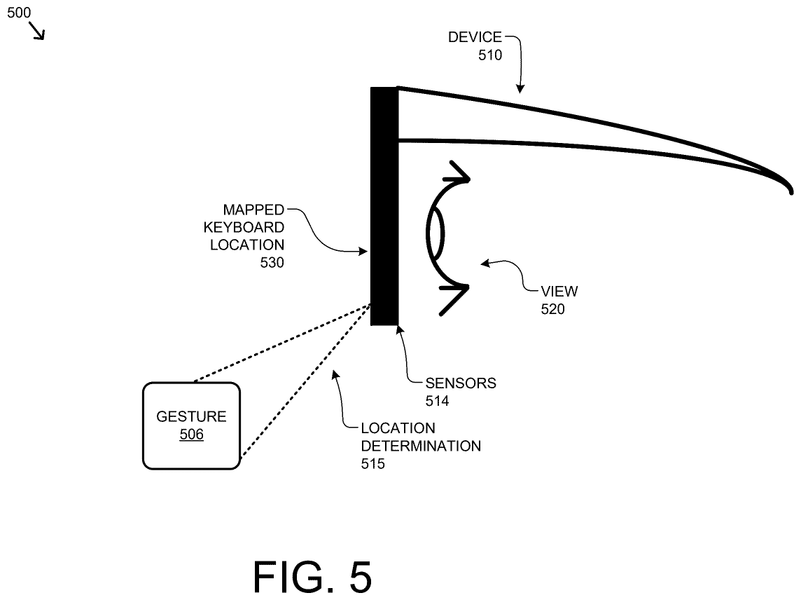

FIG. 5 illustrates an operational scenario of receiving gesture input to a virtual keyboard according to an implementation. Operational scenario 500 includes gesture 506, device 510, sensors 514, location determination 515, view 520, and mapped keyboard location 530.

In operational scenario 500, device 510 uses sensors 514, such as depth sensors and/or cameras, to perform location determination 515 to identify the location of gesture 506. In some examples, device 510 can be configured to determine the location of a pinching gesture using cameras and depth sensors that track the user's hands in 3D space. The system detects the specific motion and configuration of fingers during a pinch (e.g., thumb and index finger coming together) and calculates the gesture's position based on the location of the hand and fingertips at that moment. In some examples, the position corresponds to a coordinate in 3D space relative to the environment or the device.

From the determined location for gesture 506, device 510 determines mapped keyboard location 530. In some implementations, device 510 can identify the two-dimensional location by mapping the location of gesture 506 in the three-dimensional space to a keyboard location (i.e., mapped keyboard location 530). For example, the user can initiate a pinching gesture, and device 510 uses sensors and/or cameras to determine the location of the pinching gesture in three-dimensional space. The location can then be mapped to a two-dimensional location on the keyboard for device 510. Thus, the 3D location (e.g., position and motion) of gesture 506 is mapped to a 2D location (e.g., a character) on the display for device 510 in view 520.

In some implementations, device 510 may not display a keyboard in view 520 before the user initiates gesture 506. Instead, device 510 can detect the user starting the gesture and display a keyboard in response to the start of the gesture. In some examples, an identifier or indicator can be displayed in conjunction with the keyboard, where the identifier can be placed in an initial location on the keyboard (e.g., in the middle of the keyboard). The user can then move the gesture in space to move the identifier on the keyboard. For example, the indicator may initially be placed in the middle of the keyboard (e.g., on the letter “G”) based on the user starting their gesture. The user can then move their hand to move the identifier to the requested letter (e.g., the letter “X”). While the user's hand is in a first state or a state associated with an uncompleted gesture, the identifier can move over the keyboard without providing input. However, when the user's hand is in the second state or a state associated with completion of gesture 506, device 510 can register the input and provide the input to an application. The device can also change the identifier from a first representation to a second representation, indicating the input has been received by device 510.

In addition to a keyboard, a system can perform similar operations with other input devices. Such input devices can include keypads, a Musical Instrument Digital Interface (MIDI) controller, or an audio controller. The system can be configured to display a virtual representation of such an input device and identify input using the gesture identification operations described herein. For example, a wearable device can display a MIDI controller for a musical artist. The artist can use gestures to provide input to the MIDI controller and select one or more buttons or other interfaces using the operations described herein. For example, a user can initiate a pinching gesture, which a device identifies as a first state. The device can determine the location of the pinching gesture and determine a second location on the displayed MIDI controller based on the location. The wearable device can display an identifier in the second location, permitting the artist to identify a location of a potential input. When the user completes the gesture (e.g., an end state), an input on the MIDI controller can be identified from the current location of the gesture, and a corresponding action can be taken. As a technical effect, the artist can determine where a gesture will be input before completing the gesture.

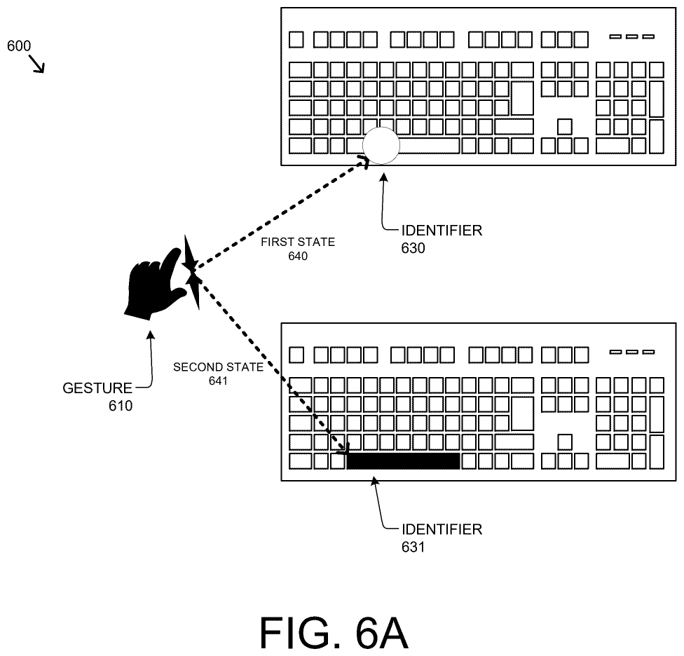

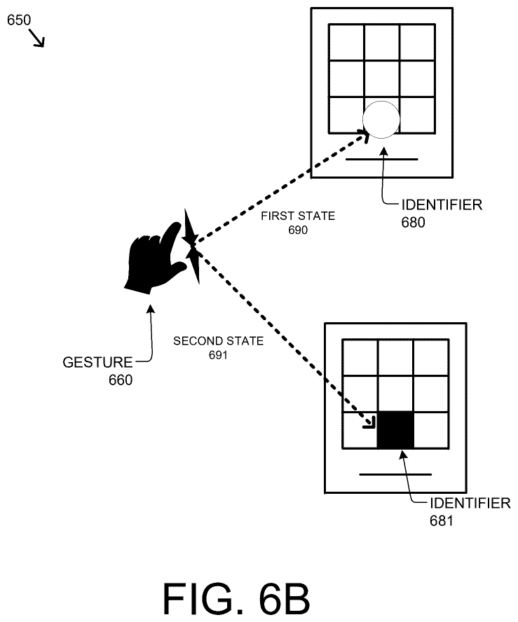

FIG. 6A illustrates an operational scenario 600 of receiving gesture input to a virtual keyboard according to an implementation. Operational scenario 600 includes gesture 610, identifier 630, identifier 631, first state 640, and second state 641. Although demonstrated as a keyboard interface, similar operations can be performed with other interfaces (i.e., virtual interfaces), such as MIDI controllers, keypads, and the like.

In operational scenario 600, a user initiates gesture 610 corresponding to a pinching gesture captured via cameras and/or depth sensors for a wearable device. The user can initiate the gesture 610 at first state 640. The wearable device can identify the start to gesture 610 by using cameras and/or depth sensors to determine the positions of the user's fingers. When the wearable device detects the thumb and index finger moving toward each other or crossing a predefined distance threshold, the wearable device can register the beginning of the pinch gesture. In some examples, the wearable device can use heuristics and rules to determine the start location of gesture 610 based on the user's hands configuration in the 3D space. The rules based at least in part on the locations of the user's hand and fingers. In some examples, the device can further use additional filtering and temporal smoothing to reduce false positives.

When in first state 640, the wearable device displays identifier 630 in association with the character corresponding to gesture 610. Identifier 630 can include an indicator, a pointer, a highlighting area, a cursor, or some other identifier that indicates the input location associated with gesture 610. Here, identifier 630 is placed on the spacebar of the virtual keyboard, indicating that when the user completes the gesture (e.g., completes the pinching motion), a spacebar will be provided as input. Although demonstrates as a circular indicator, other types of indicators can be used to indicate the potential input location to the user.

Turning to the second state 641, the user completes gesture 610, and the wearable device identifies the location of the gesture 610 at completion. In some examples, the location can correspond to the touch point between the finger and the thumb in 3D space. The location can then be mapped to a location on the keyboard. In operational scenario 600, the location corresponds to the keyboard's spacebar, and thus identifier 631 is positioned on the spacebar, indicating that the spacebar has been received as input. In addition to providing identifier 631, the wearable device can be configured to provide the input to an application or process executing on the device. Once displayed (e.g., for a threshold period), identifier 631 can be removed from the display, and the user can provide a second input using gestures in association with the keyboard or another interactive element.

Although demonstrated with a single identifier for one hand of the user, the wearable device can display multiple identifiers corresponding to inputs from both hands (e.g., two pinching gestures). In some examples, each of the identifiers will be displayed differently, permitting the user to distinguish between an input associated with the left hand and an input associated with the user's right hand. Further, when using tapping inputs, the device can display identifiers in association with any finger positioned to tap and provide input to the keyboard. In at least one example, the wearable device can display one or more virtual hands that can simulate the user's hands typing on the keyboard.

In some implementations, the device can be configured to display the keyboard in response to identifying the user initiating a gesture. For example, when the wearable device detects that the user is initiating a pinching gesture, the device can be configured to display at least a portion of a virtual keyboard. Additionally, the device can place an indicator in a starting location on the virtual keyboard, permitting the user to move the gesture to the desired character on the keyboard. In some examples, after the user provides the desired input using one or more gestures (e.g., typing a search into web browser using the methods described herein), the keyboard can determine the expiration of a timeout period for input, and remove the keyboard (including identifiers) from the display.

FIG. 6B illustrates an operational scenario 650 of receiving gesture input to an interface displayed by a wearable device according to an implementation. Operational scenario 650 includes gesture 660, identifier 680, identifier 681, first state 690, and second state 641. Operational scenario 650 demonstrates an example of providing input to a keypad. However, similar operations can be performed with other interfaces (i.e., virtual interfaces), such as MIDI controllers, virtual button panels, dial or knob interfaces, slider controls, and the like.

In operational scenario 650, a user initiates gesture 660 corresponding to a pinching gesture captured via cameras and/or depth sensors for a wearable device. The user can initiate the gesture 660 at first state 690. The wearable device can identify the start to gesture 660 by using cameras and/or depth sensors to determine the positions of the user's fingers. When the wearable device detects the thumb and index finger moving toward each other or crossing a predefined distance threshold, the wearable device can register the beginning of the pinch gesture. In some examples, the wearable device can use heuristics and rules to determine the start location of gesture 660 based on the user's hands configuration in the 3D space. The rules based at least in part on the locations of the user's hand and fingers. In some examples, the device can further use additional filtering and temporal smoothing to reduce false positives.

When in first state 690, the wearable device displays identifier 680 in association with the character corresponding to gesture 660. Identifier 680 can include an indicator, a pointer, a highlighting area, a cursor, or some other identifier that indicates the input location associated with gesture 660. Here, identifier 680 is placed on a first button of a keypad, indicating that when the user completes the gesture (e.g., completes the pinching motion), the action associated with the button will be provided as input. Although demonstrates as a circular indicator, other types of indicators can be used to indicate the potential input location to the user.

Turning to the second state 691, the user completes gesture 660, and the wearable device identifies the location of the gesture 660 at completion. In some examples, the location can correspond to the touch point between the finger and the thumb in 3D space. The location can then be mapped to a location on the keypad. In operational scenario 650, the location corresponds to a button on the keypad, and identifier 681 is positioned on the button, indicating that the button has been received as input. In addition to providing identifier 681, the wearable device can be configured to provide the input to an application or process executing on the device. Once displayed (e.g., for a threshold period), identifier 681 can be removed from the display, and the user can provide a second input using gestures in association with the displayed interface.

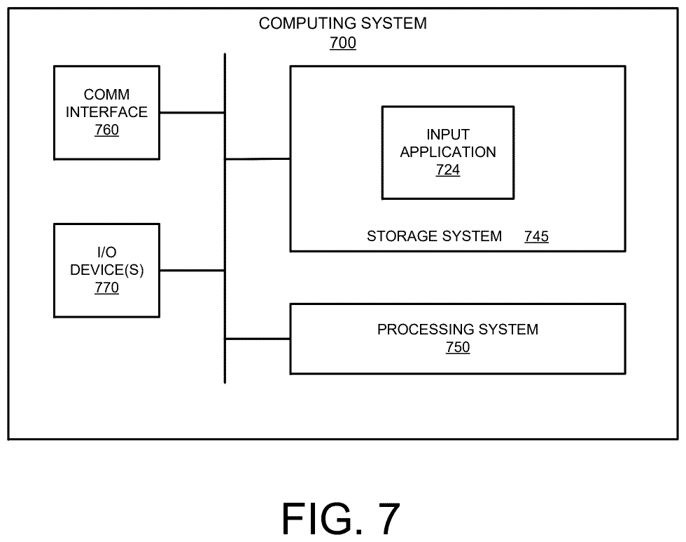

FIG. 7 illustrates a computing system 700 for providing user input to a virtual keyboard on a device according to an implementation. Computing system 700 represents any apparatus, computing system, or systems with which the various operational architectures, processes, scenarios, and sequences are disclosed herein for managing transitions between input modes. Computing system 700 can be an example of a wearable device, such as an XR device, smart glasses, or other computing device capable of the operations described herein. Computing system 700 can be an example of device 105 of FIG. 1 or device 205 of FIG. 2 in some implementations. Computing system 700 can be a system of devices, such as a wearable device and a companion device (e.g., smartphone, tablet, etc.), in some examples. Computing system 700 includes storage system 745, processing system 750, communication interface 760, and input/output (I/O) device(s) 770. Processing system 750 is operatively linked to communication interface 760, I/O device(s) 770, and storage system 745. In some implementations, communication interface 760 and/or I/O device(s) 770 may be communicatively linked to storage system 745. Computing system 700 may include other components, such as a battery and enclosure, that are not clearly shown.

Communication interface 760 comprises components that communicate over communication links, such as network cards, ports, radio frequency, processing circuitry (and corresponding software), or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or another communication format, including combinations thereof. Communication interface 760 may be configured to communicate with external devices, such as servers, user devices, or other computing devices.

I/O device(s) 770 may include peripherals of a computer that facilitate the interaction between the user and computing system 700. Examples of I/O device(s) 770 may include keyboards, mice, trackpads, monitors, displays, printers, cameras, microphones, external storage devices, sensors, and the like. In some implementations, I/O device(s) 770 include at least one outward-facing camera configured to capture images associated with the user gestures and body location. In some implementations, I/O device(s) 770 can include depth sensors and other sensors to monitor user movement and gestures.

Processing system 750 comprises microprocessor circuitry (e.g., at least one processor) and other circuitry that retrieves and executes operating software (i.e., program instructions) from storage system 745. Storage system 745 may include volatile and nonvolatile, removable, and non-removable media implemented in any method or technology for storage of information, such as computer-readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media (also referred to as computer-readable storage media or a computer-readable storage medium) include random access memory, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal.

Processing system 750 is typically mounted on a circuit board that may also hold the storage system. The operating software of storage system 745 comprises computer programs, firmware, or some other form of machine-readable program instructions. The operating software of storage system 745 comprises input application 724. The operating software on storage system 745 may further include an operating system, utilities, drivers, network interfaces, applications, or some other type of software. When read and executed by processing system 750 the operating software on storage system 745 directs computing system 700 to operate as described herein. In at least one implementation, the operating software can provide method 300 described in FIG. 3A or method 350 described in FIG. 3B. The operating software stored on computing system 700 can be configured to manage gesture entry to a virtual device, such as a keyboard, as described herein.

In at least one implementation, input application 724 directs processing system 750 to identify a first state for a gesture from a user of the wearable device. In some examples, the first state includes an incomplete or started gesture (not yet completed). For example, input application 724 can detect the user starting a pinching or tapping gesture using their hand and fingers. Input application 724 further directs processing system 750 to determine a first location associated with the gesture. In some examples, the first location can correspond to an anticipated meeting location for the completed gesture (e.g., the completed pinching or tapping). In some examples, the first location corresponds to a location in 3D space associated with completing the gesture and can be determined using sensor data associated with the wearable device, such as cameras and/or depth sensors. In some examples, the first location corresponds to a 3D position in space (e.g., X, Y, and Z coordinates, or other spatial data) relative to the environment or the device.

Input application 724 further directs processing system 750 to determine a second location on a keyboard displayed by the device based on the first location. In some implementations, the device can use a vector between the gesture location and the gaze location of the user to determine a second location on a keyboard displayed by the device. For example, the vector between the user's gaze and the gesture can intersect the displayed keyboard at a second location corresponding to the input location requested by the user. If the user raises their hand to begin a pinching motion, the vector to the pinching motion from the user's gaze can intersect the letter “S,” identifying that letter as the location on the virtual keyboard.

In some implementations, the input application 724 can use mapping or translation from the first location to the second location. Input application 724 can be configured to determine a location of the gesture in 3D space (e.g., 3D coordinate) and map or translate the location to a location on the keyboard displayed by the wearable device. In some examples, the device can maintain one or more mapping tables or data structures that can map the identified gesture location to a location in association with the keyboard. For example, the user can raise their hand to provide a pinching motion and input application 724 can determine a 3D position of the gesture. Upon identifying the pinching motion and 3D location, the device can use the mapping table to identify the location of the pinching motion on the keyboard.

Once the location on the keyboard is determined, input application 724 directs processing system 750 to cause display of an identifier in the second location on the keyboard. The identifier can include text, an image, a symbol, an arrow, or another type of identifier that indicates to a user the location associated with the potential input to the keyboard. For example, a circle can be used to indicate the location of the pinching motion on the virtual keyboard.

After displaying the identifier, input application 724 can monitor the movement of the gesture prior to the completion of the gesture. For example, the user can use a partially completed pinching gesture (e.g., fingers approaching but not touched) to move the identifier on the virtual keyboard. Once the user completes the gesture, input application 724 can identify the current location on the keyboard (i.e., current character) and provide the current character to an application or service. In some implementations, the indicator can also be changed from a first representation to a second representation, indicating that acceptance of input to the keyboard.

In some implementations, input application 724 can display multiple identifiers associated with different gesture inputs. For example, suppose the user is using their right and left hands to provide a pinching motion. In that case, one identifier can be provided for a potential input on the left side of the virtual keyboard, and a separate identifier can be provided for a potential input on the right side. Further, if the user is giving tapping inputs (e.g., tapping fingers on a tabletop or another surface), input application 724 can provide identifiers for each hand and corresponding fingers. In some implementations, the identifiers can comprise virtual hands that mimic the movement and location of the user's fingers using data from cameras and/or depth sensors.

In some implementations, the keyboard can be shown in response to determining that a user has initiated a gesture. For example, if the user is initiating a pinching motion, the device can be configured to display a virtual keyboard. In some examples, the user can provide a specific gesture to initiate the display of the keyboard. The user can also be prompted to confirm the display of the keyboard. In some examples, the gesture or gestures can include raising both hands into a potential pinching motion, raising both hands into a potential tapping motion, or other gestures. After displaying the keyboard, the user can provide specific gestures to select characters on the keyboard as described herein. The keyboard can remain on the display until a timeout period is reached, where the timeout may occur if no input has been received in a threshold period. In other examples, the keyboard may remain on the display.

As an illustrative example, a user can initiate a pinching motion using their left and right hands to enter a search into a web browser. In response to identifying the initiated gestures, input application 724 can cause the display of a keyboard and identifiers on the keyboard that are determined based on the gesture locations. Input application can receive gesture input, select one or more characters, and initiate the search. When the user has completed using the keyboard (e.g., by pressing search or a timeout period) the keyboard and any remaining indicators can be removed from the display.

Example clauses are provided below. Although these are examples, these clauses should not be considered exhaustive.

Clause 1. A method comprising: identifying a first state for a gesture from a user of a device; determining a first location associated with the gesture; determining a second location on an interface displayed by the device based on the first location; and causing display of an identifier in the second location on the interface.

Clause 2. The method of clause 1 further comprising: identifying a second state for the gesture from the user; and in response to identifying the second state, identifying an input associated with the second location.

Clause 3. The method of clause 2 further comprising: providing the input to an application on the device.

Clause 4. The method of clause 2, wherein the identifier is displayed as a first representation, and the method further comprising: in response to identifying the second state, causing display of the identifier as a second representation.

Clause 5. The method of clause 1, wherein the gesture is a first gesture and is associated with a first hand of the user, and wherein the method further comprises: identifying a second gesture from the user of the device, the second gesture provided by a second hand of the user; determining a third location associated with the second gesture; identifying a fourth location on the interface displayed by the device based on the third location; and causing display of a second identifier on the fourth location on the interface.

Clause 6. The method of clause 1, wherein the gesture comprises a pinching gesture or a tapping gesture.

Clause 7. The method of clause 1 further comprising: determining a gaze associated with the user, wherein determining the second location on the interface displayed by the device based on the first location is further based on the gaze associated with the user.

Clause 8. The method of clause 1, wherein the interface comprises a keyboard, and the method further comprising: identifying a set of one or more keyboard characters input by the user, wherein determining the second location on the interface displayed by the device based on the first location is further based on the set of one or more keyboard characters input by the user.

Clause 9. A system comprising: at least one processor; a computer-readable storage medium operatively coupled to the at least one processor; and program instructions stored on the computer-readable storage medium that, when executed by the at least one processor, direct the system to perform a method, the method comprising: identifying a first state for a gesture from a user of a device; determining a first location associated with the gesture; determining a second location on an interface displayed by the device based on the first location; and causing display of an identifier in the second location on the interface.

Clause 10. The system of clause 9, wherein the method further comprises: identifying a second state for the gesture from the user; and in response to identifying the second state, identifying an input associated with the second location.

Clause 11. The system of clause 10, wherein the method further comprises: providing the input to an application on the device.

Clause 12. The system of clause 10, wherein the identifier is displayed as a first representation, and the method further comprises: in response to identifying the second state, causing display of the identifier as a second representation.

Clause 13. The system of clause 9, wherein the gesture is a first gesture and is associated with a first hand of the user, and wherein the method further comprises: identifying a second gesture from the user of the device, the second gesture provided by a second hand of the user; determining a third location associated with the second gesture; identifying a fourth location on the interface displayed by the device based on the third location; and causing display of a second identifier on the fourth location on the interface.

Clause 14. The system of clause 9, wherein the gesture comprises a pinching gesture or a tapping gesture.

Clause 15. The system of clause 9, wherein the method further comprises: determining a gaze associated with the user, wherein determining the second location on the interface displayed by the device based on the first location is further based on the gaze associated with the user.

Clause 16. The system of clause 9, wherein the interface comprises a keyboard, and wherein the method further comprises: identifying a set of one or more keyboard characters input by the user, wherein determining the second location on the interface displayed by the device based on the first location is further based on the set of one or more keyboard characters input by the user.

Clause 17. A computer-readable storage medium having program instructions stored thereon that, when executed by at least one processor, direct the at least one processor to perform a method, the method comprising: identifying a first state for a gesture from a user of a device; determining a first location associated with the gesture; determining a second location on an interface displayed by the device based on the first location; and causing display of an identifier in the second location on the interface.

Clause 18. The computer-readable storage medium of clause 17, wherein the method further comprises: identifying a second state for the gesture from the user; and in response to identifying the second state, identifying an input associated with the second location.

Clause 19. The computer-readable storage medium of clause 18, wherein the method further comprises: providing the input to an application on the device.

Clause 20. The computer-readable storage medium of clause 18, wherein the gesture comprises a pinching gesture between a finger and a thumb, wherein the first state includes a first position for the finger relative to the thumb, and wherein the second state includes a second position for the finger relative to the thumb.

In this specification and the appended claims, the singular forms “a,” “an” and “the” do not exclude the plural reference unless the context dictates otherwise. Further, conjunctions such as “and,” “or,” and “and/or” are inclusive unless the context dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections, or logical connections may be present in a practical device. Moreover, no item or component is essential to the practice of the implementations disclosed herein unless the element is specifically described as “essential” or “critical.”

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, the use of terms such as up, down, top, bottom, side, end, front, back, etc. herein are used concerning a currently considered or illustrated orientation. If they are considered concerning another orientation, such terms must be correspondingly modified.

Further, in this specification and the appended claims, the singular forms “a,” “an” and “the” do not exclude the plural reference unless the context dictates otherwise. Moreover, conjunctions such as “and,” “or,” and “and/or” are inclusive unless the context dictates otherwise. For example, “A and/or B” includes A alone, B alone, and A with B.

Although certain example methods, apparatuses, and articles of manufacture have been described herein, the scope of coverage of this patent is not limited thereto. It is to be understood that the terminology employed herein is to describe aspects and is not intended to be limiting. On the contrary, this patent covers all methods, apparatus, and articles of manufacture fairly falling within the scope of the claims of this patent.

What is claimed is:

1. A method comprising:
identifying a first state for a gesture from a user of a device;
in response to identifying the first state, determining a first location associated with the gesture;
determining a second location on an interface displayed by the device based on the first location; and
causing display of an identifier in the second location on the interface.

2. The method of claim 1 further comprising:
identifying a second state for the gesture from the user; and
in response to identifying the second state, identifying an input associated with the second location.

3. The method of claim 2 further comprising:
providing the input to an application on the device.

4. The method of claim 2, wherein the identifier is displayed as a first representation, and the method further comprising:
in response to identifying the second state, causing display of the identifier as a second representation.

5. The method of claim 1, wherein the gesture is a first gesture and is associated with a first hand of the user, and wherein the method further comprises:
identifying a second gesture from the user of the device, the second gesture provided by a second hand of the user;
determining a third location associated with the second gesture;
identifying a fourth location on the interface displayed by the device based on the third location; and
causing display of a second identifier on the fourth location on the interface.

6. The method of claim 1, wherein the gesture comprises a pinching gesture or a tapping gesture.

7. The method of claim 1 further comprising:
determining a gaze associated with the user,
wherein determining the second location on the interface displayed by the device based on the first location is further based on the gaze associated with the user.

8. The method of claim 1, wherein the interface comprises a keyboard, and the method further comprising:
identifying a set of one or more keyboard characters input by the user,
wherein determining the second location on the interface displayed by the device based on the first location is further based on the set of one or more keyboard characters input by the user.

9. A system comprising:
at least one processor;
a computer-readable storage medium operatively coupled to the at least one processor; and
program instructions stored on the computer-readable storage medium that, when executed by the at least one processor, direct the system to perform a method, the method comprising:
identifying a first state for a gesture from a user of a device;
in response to identifying the first state, determining a first location associated with the gesture;
determining a second location on an interface displayed by the device based on the first location; and
causing display of an identifier in the second location on the interface.

10. The system of claim 9, wherein the method further comprises:
identifying a second state for the gesture from the user; and
in response to identifying the second state, identifying an input associated with the second location.

11. The system of claim 10, wherein the method further comprises:
providing the input to an application on the device.

12. The system of claim 10, wherein the identifier is displayed as a first representation, and the method further comprises:
in response to identifying the second state, causing display of the identifier as a second representation.

13. The system of claim 9, wherein the gesture is a first gesture and is associated with a first hand of the user, and wherein the method further comprises:
identifying a second gesture from the user of the device, the second gesture provided by a second hand of the user;
determining a third location associated with the second gesture;
identifying a fourth location on the interface displayed by the device based on the third location; and
causing display of a second identifier on the fourth location on the interface.

14. The system of claim 9, wherein the gesture comprises a pinching gesture or a tapping gesture.

15. The system of claim 9, wherein the method further comprises:
determining a gaze associated with the user,
wherein determining the second location on the interface displayed by the device based on the first location is further based on the gaze associated with the user.

16. The system of claim 9, wherein the interface comprises a keyboard, and wherein the method further comprises:
identifying a set of one or more keyboard characters input by the user,
wherein determining the second location on the interface displayed by the device based on the first location is further based on the set of one or more keyboard characters input by the user.

17. A computer-readable storage medium having program instructions stored thereon that, when executed by at least one processor, direct the at least one processor to perform a method, the method comprising:
identifying a first state for a gesture from a user of a device;
in response to identifying the first state, determining a first location associated with the gesture;
determining a second location on an interface displayed by the device based on the first location; and
causing display of an identifier in the second location on the interface.

18. The computer-readable storage medium of claim 17, wherein the method further comprises:
identifying a second state for the gesture from the user; and
in response to identifying the second state, identifying an input associated with the second location.

19. The computer-readable storage medium of claim 18, wherein the method further comprises:
providing the input to an application on the device.

20. The computer-readable storage medium of claim 18, wherein the gesture comprises a pinching gesture between a finger and a thumb, wherein the first state includes a first position for the finger relative to the thumb, and wherein the second state includes a second position for the finger relative to the thumb.
